(19) United States
(12) Patent Application Publication
(10) Pub. No.: US 2026/0158789 A1
(43) Pub. Date: Jun. 11, 2026

(54) PRINTING APPARATUS AND CONTROL METHOD OF PRINTING APPARATUS

(71) Applicant: CANON KABUSHIKI KAISHA, Tokyo (JP)

(72) Inventors: SHUNNOSUKE KOSEKI, Kanagawa (JP); TAKESHI MURASE, Kanagawa (JP); HIROSHI TAIRA, Tokyo (JP); SAE MOGI, Kanagawa (JP); HIROTO KANGO, Tokyo (JP)

(21) Appl. No.: 19/398,144

(22) Filed: Nov. 24, 2025

(30) Foreign Application Priority Data
Dec. 6, 2024 (JP) 2024-213898

(51) Int. Cl. B41J 2/165; B41J 2/045

(52) U.S. Cl. CPC B41J 2/16552; B41J 2/04553; B41J 2/04566; B41J 2/04573; B41J 2/0458; B41J 2002/16558; B41J 2002/16576

(57) ABSTRACT

Provided is a technique for a printing apparatus to suppress damage and a reduction in productivity of the apparatus. To this end, print scanning by the print head is performed after the cleaning liquid is applied to the wiping member by the cleaning liquid application unit until the wiping operation is performed by the wiping member.

### BACKGROUND

### Field of the Invention

The present disclosure relates to a printing apparatus that wipes an ejection port surface of a print head and a control method of the printing apparatus.

### Description of the Related Art

Japanese Patent Laid-Open No. 2005-238611 discloses an ink jet printing apparatus including a maintenance mechanism that performs a wiping operation by pressing a cleaning member (a wiping member) in the form of a tape to which a cleaning liquid is applied onto an ejection port surface of an ink jet head.

In a case where the cleaning liquid is applied to the wiping member, the time required for the cleaning liquid to be spread on the wiping member varies depending on the amount of the applied cleaning liquid. In a case where a small amount of the cleaning liquid is applied, more time is required to be spread than a case of applying a great amount of the cleaning liquid.

In addition, in a case where an ejection port of the print head is wiped with the wiping member, the cleaning liquid needs to be spread on the wiping member sufficiently.

However, Japanese Patent Laid-Open No. 2005-238611 does not describe a timing to apply the cleaning liquid to the cleaning member to perform a cleaning operation.

As described above, in a case where a small amount of the cleaning liquid is applied, the spreading takes time; for this reason, there is a concern about a reduction in throughput due to waiting for the spreading. Additionally, in a case where the wiping is performed in a state without sufficient spreading, there is a possibility of damaging a water-repellent film on the uppermost surface of the ejection port surface.

### SUMMARY

Therefore, the present disclosure provides a technique for a printing apparatus to suppress damage and a reduction in the productivity of the apparatus.

To this end, a printing apparatus of the present disclosure includes: a print head including an ejection port surface in which an ejection port to eject an ink is provided; at least one wiping member configured to wipe the ejection port surface; a movement unit configured to move the wiping member in a wiping operation to wipe the ejection port surface with the wiping member; and a cleaning liquid application unit configured to apply a cleaning liquid to the wiping member before the wiping operation, in which the printing apparatus is an ink jet printing apparatus configured to perform the wiping operation by putting the wiping member to which the cleaning liquid is applied in contact with the ejection port surface, and print scanning by the print head is performed after the cleaning liquid is applied to the wiping member by the cleaning liquid application unit until the wiping operation is performed by the wiping member.

According to the present disclosure, it is possible to provide a technique for a printing apparatus to suppress damage and a reduction in the productivity of the apparatus.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating exterior of a printing apparatus;

FIG. 2 is a perspective view illustrating a print head;

FIG. 3 is a block diagram illustrating a schematic configuration of a control system of the printing apparatus;

FIG. 4 is a cross-sectional view illustrating a maintenance mechanism and a recovery processing device;

FIG. 5 is a cross-sectional view illustrating a carriage on which the print head is mounted and the maintenance mechanism;

FIG. 6 is a diagram illustrating a sheet member to which no cleaning liquid is applied;

FIG. 7 is a diagram illustrating the sheet member to which the cleaning liquid is applied;

FIG. 8 is a diagram illustrating the sheet member to which the cleaning liquid is applied.

FIG. 9 is a flowchart illustrating a wiping sequence;

FIG. 10A is a diagram illustrating a positional relationship between the print head and the maintenance mechanism;

FIG. 10B is a diagram illustrating the positional relationship between the print head and the maintenance mechanism;

FIG. 10C is a diagram illustrating the positional relationship between the print head and the maintenance mechanism;

FIG. 11 is a graph illustrating a relationship between a spread width and time;

FIG. 12 is a flowchart illustrating processing of a print job;

FIG. 13 is a graph illustrating evaporation characteristics at each environmental temperature and humidity after the cleaning liquid is applied to the sheet member;

FIG. 14 is a graph illustrating the spread width in a case where the cleaning liquid is applied to the sheet member;

FIG. 15 is a flowchart illustrating processing of the print job; and

FIG. 16 is a graph illustrating the spread width with each application amount of the cleaning liquid.

### DESCRIPTION OF THE EMBODIMENTS

### First Embodiment

In the following, a first embodiment of the present disclosure is described with reference to the drawings. In the present specification, “printing” indicates not only a case of forming significant information such as a character and a graphic, and the information is irrespective of whether significant or insignificant. Additionally, “printing” also indicates widely a case of forming an image, a design, a pattern, and the like on a printing medium and processing the medium regardless of whether it is actualized such that humans can visually perceive. Moreover, the “printing medium” indicates not only paper used by a general printing apparatus but also indicates widely something that can accept ink such as cloth, a plastic film, a metal plate, glass, ceramics, wood, and leather. In addition, the “ink” (also referred to as a “liquid”) should be construed widely as with the definition of the “printing” described above. Accordingly, the “ink” indicates a liquid that can be used for formation of an image, a design, a pattern, and the like or processing of the printing medium by being applied on the printing medium, or for processing of the ink (for example, solidification or insolubilization of a color material in the ink applied on the printing medium). Furthermore, unless otherwise stated, a “nozzle” summarizes an ejection port or a fluid channel communicating therewith and an element that generates energy utilized for ink ejection.

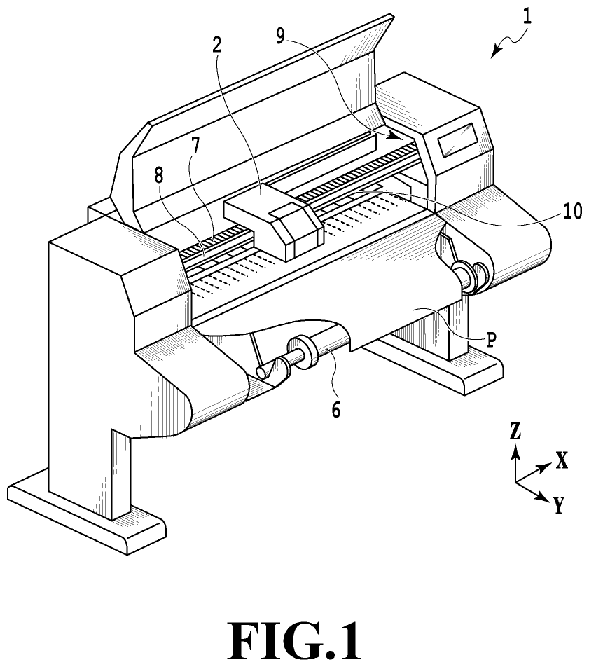

FIG. 1 is a diagram illustrating exterior of a printing apparatus 1 in the present embodiment. The printing apparatus 1 is a so-called serial scanning type printing apparatus, which forms an image by scanning (main scanning) a print head in a direction orthogonal to a conveyance direction of a print medium P (a main scanning direction). In FIG. 1, an X direction is a scanning direction of a carriage 2, a Y direction is the conveyance direction of the print medium P, and a Z direction is a vertical direction. In the following, a configuration of the printing apparatus 1 and an overview of a print operation are described with reference to FIG. 1.

Once the printing apparatus 1 starts the print operation, the print medium Pis conveyed in the Y direction from a spool 6 holding the print medium P by a conveyance roller driven by a not-illustrated conveyance motor via a gear. On the other hand, the carriage 2 is reciprocally scanned (reciprocally moved) along a guide shaft 8 extending in the X direction by a not-illustrated carriage motor in a predetermined conveyance position. Then, in the scanning process, an ejection operation from an ejection port of the later-described print head mountable on the carriage 2 is performed in a timing based on a position signal obtained by a linear encoder 7, and printing of a certain bandwidth corresponding to an array range of the ejection port is performed. In the present embodiment, scanning is performed at a scanning speed of 40 inches per second, and the ejection operation is performed at a resolution of 1200 dpi ( 1/1200 inches). Thereafter, the print medium Pis conveyed, and printing of a next bandwidth is performed.

The print medium P fed from the spool 6 is pinched by a feeding roller and a pinch roller to be conveyed and guided to a print position on a platen 4 (a scanning region of the print head). Usually, in an inactive state, the ejection port surface of the print head in which the ejection port is formed is covered with a cap; for this reason, the ejection port surface is released from the cap in advance to perform printing to allow for scanning of the print head or the carriage 2. Thereafter, once data of single scanning is accumulated in a buffer, the carriage 2 is scanned by the carriage motor, and printing is performed as described above.

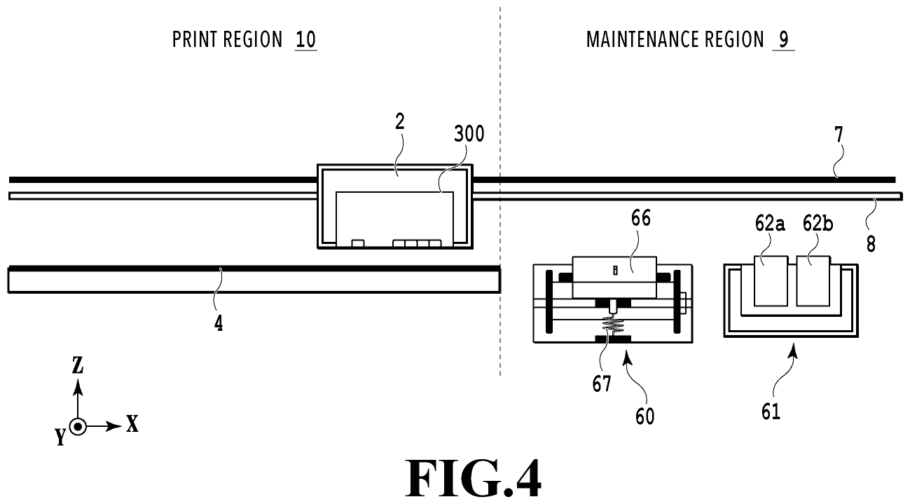

A maintenance mechanism 60 and a recovery processing device 61 (see FIG. 4) described later are provided in a maintenance region 9.

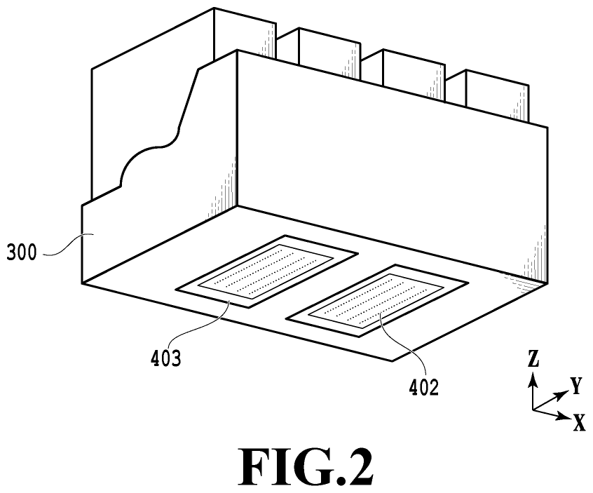

FIG. 2 is a perspective view illustrating a print head 300. The print head 300 includes an ejection port surface 403 on which multiple ejection port arrays 402 including multiple ejection ports arrayed to eject inks are provided, and the ejection port arrays 402 are arranged side by side so as to be able to eject different color tones of inks along a movement direction of the carriage 2. For example, the ejection port arrays 402 that are capable of ejecting inks of cyan (C), magenta (M), yellow (Y) and black (Bk) are arranged side by side along the X direction, which is the movement direction of the carriage 2. Note that, the order of arrangement of the ejection port arrays 402 is not limited thereto. The ejection port arrays 402 are formed of 1280 ejection ports that are arrayed in the Y direction (an array direction) at a density of 1200 dpi to eject each ink. Note that, an ejection amount of the ink ejected at one time from a single ejection port in the present embodiment is about 5 μl.

The print head 300 in the present embodiment is an ink jet type print head that ejects the ink by utilizing heat energy and includes multiple electrothermal converters that generate the heat energy. The print head 300 generates the heat energy by a pulse signal applied to the electrothermal converters, causes film boiling of the ink in a not-illustrated ink bubbling chamber by the heat energy, and ejects the ink from the ejection port by utilizing a bubbling pressure of the film boiling. Note that, a method of ejecting the ink is not limited thereto, and a method using a piezoelectric element may be applied.

As the print head 300, multiple print heads capable of ejecting one or more colors of inks may be mounted on the carriage, or a single print head capable of ejecting multiple colors of inks may be mounted on the carriage 2. Additionally, the ink supplied to the print head 300 is supplied from inside of a print head main body or supplied from an ink tank (not illustrated) mounted on an external unit through a supply tube by way of the carriage 2. Supplying of the ink to the print head 300 may be supplying from the ink tank to the print head 300 by using a pressurization unit, or the ejection port surface 403 of the print head 300 may be capped by using a cap of a recovery unit to supply the ink by sucking by a suction pump.

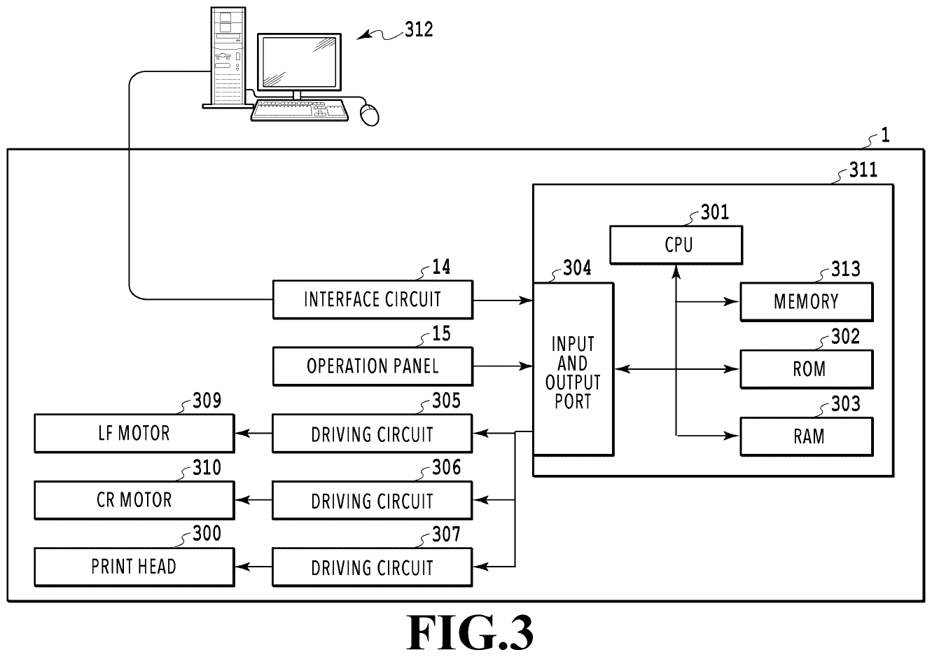

FIG. 3 is a block diagram illustrating a schematic configuration of a control system of the printing apparatus 1 connected with a host computer 312. A main control unit 311 includes a CPU 301 that executes a processing operation such as computation and control and a print operation, a ROM 302 that stores a control program and the like executed by the CPU 301, a RAM 303 used as the buffer of print data and the like, a memory 313, an input and output port 304, and the like. In order to control each driving system, the CPU 301 is connected to a sensor group (not illustrated) that detects an operation and a position of each unit. A sensor included in the sensor group may be, for example, a carriage sensor that detects a position of the carriage in the main scanning direction. Additionally, the sensor group also includes a conveyance system sensor and the like that detect the conveyance operation of the print medium P by the conveyance roller and the position of the conveyed print medium P.

The memory 313 stores a mask pattern and the like. In addition, the input and output port 304 is connected to a conveyance motor (an LF motor) 309, a carriage motor (a CR motor) 310, the print head 300, an operation panel 15, the recovery processing device (not illustrated), the maintenance mechanism (not illustrated), and driving circuits 305, 306, and 307. In addition, the main control unit 311 is connected to the host computer 312 via an interface circuit 14.

FIG. 4 is a cross-sectional view illustrating the maintenance mechanism 60 and the recovery processing device 61 provided to the printing apparatus 1 in the present embodiment. The maintenance mechanism 60 and the recovery processing device 61 are disposed in a position facing the print head 300 in the maintenance region 9. The carriage 2 on which the print head 300 is mounted, which is supported by the guide shaft 8, is moved toward the maintenance mechanism 60 and the recovery processing device 61 based on the signal from the linear encoder 7.

The recovery processing device 61 is arranged in the maintenance region 9 adjacent to a print region 10. The print region 10 is a position in which the ejection port array 402 of the print head 300 faces the print medium P supported by the platen 4. The maintenance region 9 is provided in a position in which the carriage 2 moved from the print region 10 arrives, and the ejection port array 402 of the print head 300 faces the maintenance mechanism 60 and the recovery processing device 61 in the position in the maintenance region 9.

The recovery processing device 61 includes a not-illustrated suction recovery mechanism that performs suction recovery processing and an ascending/descending mechanism that allows the suction recovery mechanism to ascend/descend. The suction recovery processing herein is processing to maintain the ink in the ejection port to a state appropriate for ejection by forcibly sucking the ink from the multiple ejection ports formed in the print head 300. Specifically, the suction recovery mechanism includes a cap 62 that covers an ejection port formation surface and a pump communicating with the cap. The pump generates a negative pressure in the cap, and the ink in the ejection port is forcibly sucked by the negative pressure. Additionally, ejection of the ink evaporated and thickened in the ejection port, which is performed without printing and is referred to as auxiliary ejection, is performed on the recovery processing device 61.

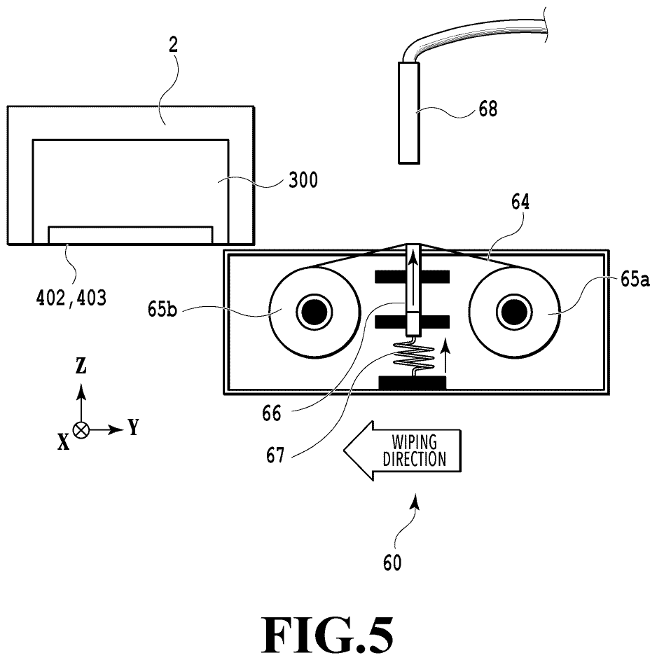

FIG. 5 is a cross-sectional view illustrating the carriage 2 on which the print head 300 is mounted and the maintenance mechanism 60. The maintenance mechanism 60 includes a wiping member 64 formed of a porous material in the form of a sheet (such as an unwoven cloth) that is capable of wiping the ink attached to the ejection port of the print head 300. In wiping, the wiping member 64 formed of the porous material sucks and draws out the ink from the ejection port more easily than a wiping member formed of an elastic material (such as a wiper made of rubber) does; for this reason, the effect of the present embodiment is further produced. Additionally, in addition to a cleaning liquid described later, the wiping member 64 may be impregnated with an impregnating fluid containing a solvent with low volatility such as polyethylene glycol as a main component, for example. In the following, the wiping member 64 in the form of a sheet is also referred to as a “sheet member.”

The sheet member 64 that is unused (before wiping the ink) is wound around a rotation member 65a (a first rotation member). A rotation member 65b (a second rotation member) is arranged upstream of the rotation member 65a in the Y direction, which is the conveyance direction of the sheet. A tip of the sheet member 64 is attached to the rotation member 65b, and the rotation member 65b rolls up the sheet member 64 that is used (after wiping the ink) by being driven by the conveyance motor. Thus, the sheet member 64 is conveyed to the upstream side of the Y direction, which is the conveyance direction of the sheet. On the other hand, the rotation member 65a is driven and rotated according to the rotation of the rotation member 65b.

A conveyance length (a conveyance amount) of the sheet member 64 is controlled by a rotation amount of the conveyance motor; however, the conveyance length may be controlled based on a measurement result of a conveyance length measurement unit using a publicly-known unit, for example, an optical unit. In this case, it is preferable to provide a scale for length measurement to an end portion along the conveyance direction of the sheet member 64.

A pressing member 66 is arranged between the rotation member 65a and the rotation member 65b. The pressing member 66 is movable in the Z direction and is able to move between a wiping position in which wiping of the ejection port surface 403 can be performed and a standby position retracted from the wiping position. The pressing member 66 pushes up the sheet member 64 by a certain load in the Z direction by a compression spring 67. In a case of wiping, the pressing member 66 pushes up the sheet member 64 to a pressing position (the wiping position) in which a part of the sheet member 64 is pushed up to be put in contact with the ejection port array 402 (the ejection port surface 403). The longer the length in the Y direction of the sheet member 64 that is put in contact with the ejection port array 402 by the pressing member 66, the higher the cleaning effect by wiping. In the present embodiment, a width of the pressing member 66 in the Y direction is set such that the length of the sheet member 64 that is put in contact with the ejection port array 402 by the pressing member 66 is about 5 mm, and the length of the sheet member 64, which is about 5 mm, is a length that allows about 250 ejection ports to be put in contact with the sheet member 64 concurrently for each color.

Additionally, a width of the sheet member 64 in the X direction that is put in contact with the print head 300 by the pressing member 66 is a width that allows for wiping of all the ejection port arrays 402 on the print head 300. In addition, the width of the sheet member 64 in the X direction that is put in contact with the print head 300 by the pressing member 66 is set to the width that allows for wiping of the entire ejection port surface 403 (see FIG. 2) of the print head 300, and thus it is possible to wipe also mist that is attached and spreading on the entire ejection port surface. Thus, the ink is never solidified on the ejection port surface 403 with which the cap is put in contact, and therefore it is possible to put the cap in contact with the ejection port surface 403 closely without clearance.

In the present embodiment, the width of the pressing member 66 in the X direction is longer than the width of the print head 300 in the X direction, and thus the width of the sheet member 64 put in contact with the print head 300 by the pressing member 66 is almost the same as the width of the print head 300.

In the present embodiment, in a case of the wiping operation, the ejection port surface 403 of the print head 300 is wiped by moving the maintenance mechanism 60 in a-Y direction in a state in which the pressing member 66 is positioned in the wiping position.

Note that, the sheet member 64 may be one sheet, or the sheet member 64 may be multiple sheets depending on the position of the ejection port array of each ink on the print head 300, or in a case where there are multiple print heads. The divided number of the sheet members, a width and a length of each sheet member, and the like have no restriction.

Although an uneven cloth with polyester short fibers is used as the sheet member 64 in the present embodiment, a raw material and a manufacturing method are not particularly limited. The uneven cloth has the form of a sheet in which the fibers are fused and bonded or intertangled by mechanical and chemical actions. In addition, the knitted or woven form of a sheet with long fibers may be applied. Additionally, as a material of the sheet member, mixture of polyester and nylon, cotton, and the like are also used. Moreover, the wiping member 64 may not have the form of a sheet and may be a block-shaped sponge (a porous body) or the like. In this case, the block-shaped sponge may be configured to be movable upward and downward and provided to be able to be put in contact with the print head 300 without using the pressing member 66.

The cleaning liquid applied to the sheet member 64 is supplied before wiping from a not-illustrated cleaning liquid tank using a supply nozzle 68 through a cleaning liquid supply tube by a pressurization mechanism. The supply nozzle 68 is configured to be able to drop the cleaning liquid, and the supply nozzle 68 drops the cleaning liquid onto a region of the sheet member 64 that is to be pressed on the ejection port surface 403 by the pressing member 66. A not-illustrated electromagnetic valve is provided to an upstream flow channel of the supply nozzle 68 to control an application amount of the cleaning liquid based on a release time of the electromagnetic valve.

Next, the cleaning liquid used in the present embodiment is described. In the following, “parts” is based on a mass unless otherwise stated.

The cleaning liquid is preferably a solution including a solvent that disperses the solidified ink again. Additionally, the solvent may have a function of a humectant, a surfactant, a pH stabilizer, or a preservative. In the present embodiment, the cleaning liquid was prepared by mixing and agitating the following components sufficiently, and pressurizing and filtering the components by a microfilter of a pore size of 2.5 μm (manufactured by FUJIFILM Corporation).

| | | |
|---|---|---|
| 1-2 hexanediol | 3 | parts |
| triethylene glycol | 25 | parts |
| acetylene glycol EO adduct | 2 | parts |

ion-exchange water (manufactured by Kawaken Fine Chemicals Co., Ltd.) rest of the parts

The action of the cleaning liquid is, first, facilitating the wiping by dispersing again the attached mist and the solidified ink on the ejection port surface 403 by wiping the ink with the sheet member to which the cleaning liquid is applied. Secondly, the action is preventing the color material from damaging the ejection port surface 403 by impregnating the wiped ink, which is particularly the ink that deteriorates the water-repellent film of the ejection port surface 403, to the inside of the sheet member 64 rapidly.

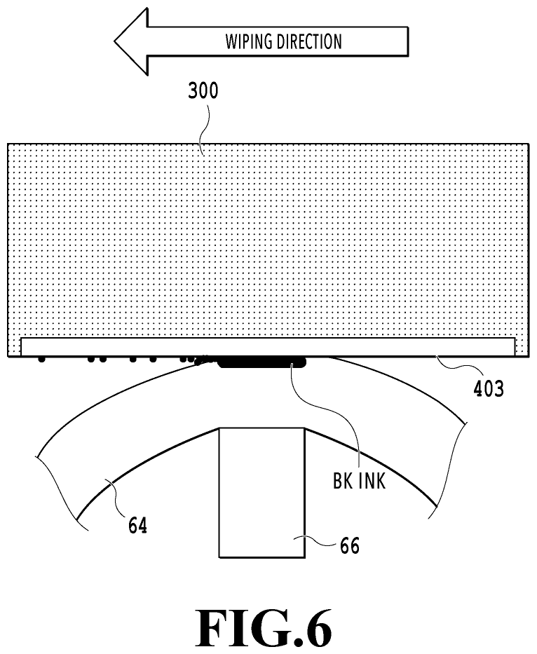

FIG. 6 is a diagram illustrating the sheet member 64 to which no cleaning liquid is applied that wipes the mist of the black ink attached to the ejection port surface 403. In a case of wiping with the sheet member 64 to which no cleaning liquid is applied, the mist of the black ink is transferred to the sheet member 64, but the solidified mist of the black ink remains without transferring to the sheet member 64. Additionally, most of the color material that is transferred to the sheet member 64 remains on the uppermost surface of the sheet member 64 that is put in contact with the ejection port surface 403. The highly concentrated color material of the black ink remaining on the uppermost surface is put in contact with the water-repellent film on the uppermost surface of the ejection port surface by the wiping operation, and there is a possibility of damaging the water-repellent film.

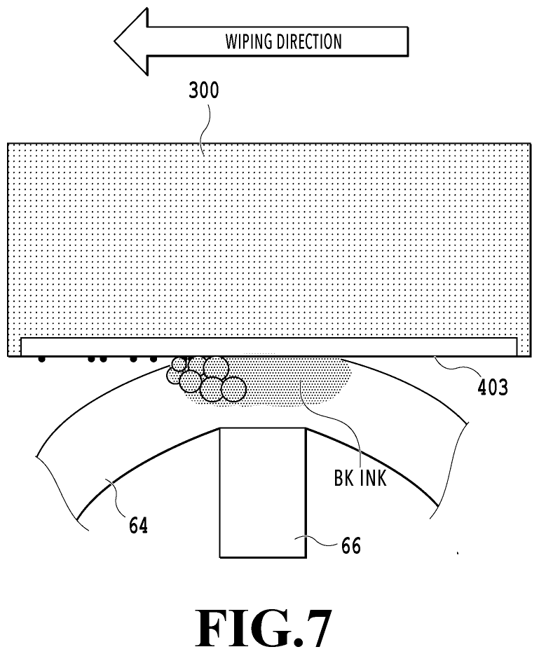

FIG. 7 is a diagram illustrating the sheet member 64 to which the cleaning liquid is applied that wipes the mist of the black ink attached to the ejection port surface 403. In a case of wiping with the sheet member 64 to which the cleaning liquid is applied, the mist of the black ink that is transferred to the sheet member 64 rapidly permeates the inside of the sheet member 64 deeply and widely, and a little amount of the color material remains on the surface of the sheet member 64. For this reason, the possibility of damaging the ejection port surface 403 is low even in a case of the ink that deteriorates the water-repellent film. Additionally, the solidified mist of the black ink is dispersed again and is easily transferred to the sheet member 64 by being put in contact with the cleaning liquid applied to the sheet member 64.

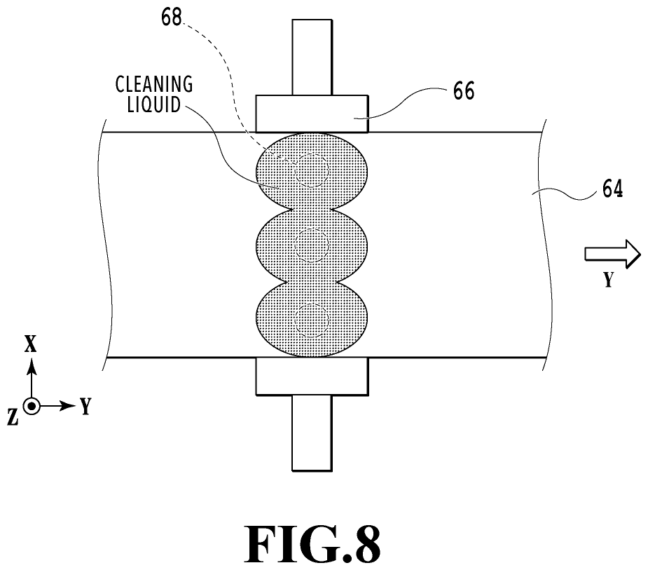

FIG. 8 is a diagram illustrating the sheet member 64 to which the cleaning liquid is applied. A width of a portion of the sheet member 64 in the X direction that becomes a wet state by applying the cleaning liquid to the sheet member 64 may be only the width of the ejection port array of the print head 300 or may be a width that covers the entire ejection port surface of the print head 300. In the present embodiment, in the X direction, the sheet member 64 in the wet state with the cleaning liquid wipes the entire region of the ejection port surface 403 of the print head 300. To this end, three supply nozzles 68 are provided along the X direction.

The width of the ejection port surface 403 in the X direction in the present embodiment is 75 mm. Therefore, a spread width of the cleaning liquid applied from each supply nozzle 68 needs to be 25 mm or greater in the X direction. In the following, the spread width of 25 mm is referred to as a “desired spread width.” In the present embodiment, the application amount of the cleaning liquid is 0.1 g for each nozzle, and the desired spread width of 25 mm is obtained from the cleaning liquid applied by each supply nozzle 68 by dropping and applying the cleaning liquid from the three nozzles to the sheet member 64.

Note that, although the cleaning liquid is applied by the supply nozzle 68 in the present embodiment, a configuration of the application is not limited thereto, and the cleaning liquid may be applied by a spray method, may be applied by transference using an application roller, or may be applied from a hole provided in the pressing member 66. Additionally, a configuration to supply the cleaning liquid while moving one nozzle in the X direction may be applied.

The wiping operation in the present embodiment is performed in the following timing.
at beginning of printing
during print operation
between pages
before cap closing operation
during cleaning sequence (during suction recovery sequence)

The wiping operation at the beginning of the print operation is the wiping operation before performing printing of the first page, which is performed for the possibility that the ejection port surface 403 is contaminated by the ink attached to the cap in a standby state, or the mist is attached to the ejection port surface 403 by the auxiliary ejection performed in the standby state.

The wiping operation during the print operation is performed as periodical maintenance to prevent the mist of the own color/another color of the ink from the print head 300 from covering the ejection port, being attached and solidified on the ejection port surface 403, and gathering as a large amount of mist and dropping a large liquid droplet, which occur during the print operation.

The wiping operation between pages is performed in a timing after ending printing a previous page and before printing the next page, and in some cases, the wiping operation between pages is performed in a timing of cutting the print medium P by cutter processing after ending printing all the pages.

The wiping operation before the cap closing operation is performed to perform maintenance after ending printing and before capping the print head 300.

The wiping operation during the cleaning sequence is executed to wipe a large amount of the ink droplets attached to the ejection port surface after performing the recovery processing such as ink suction using the cap.

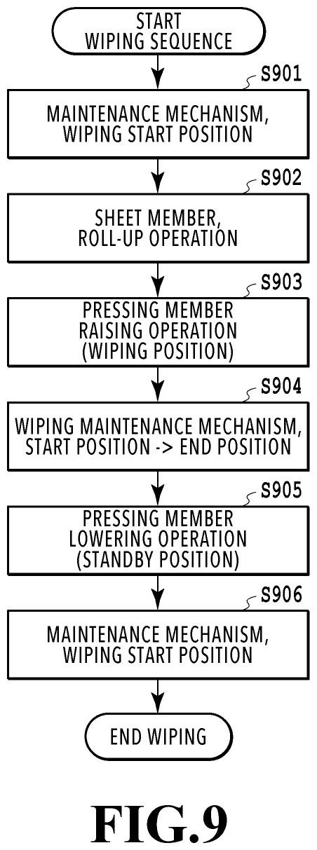

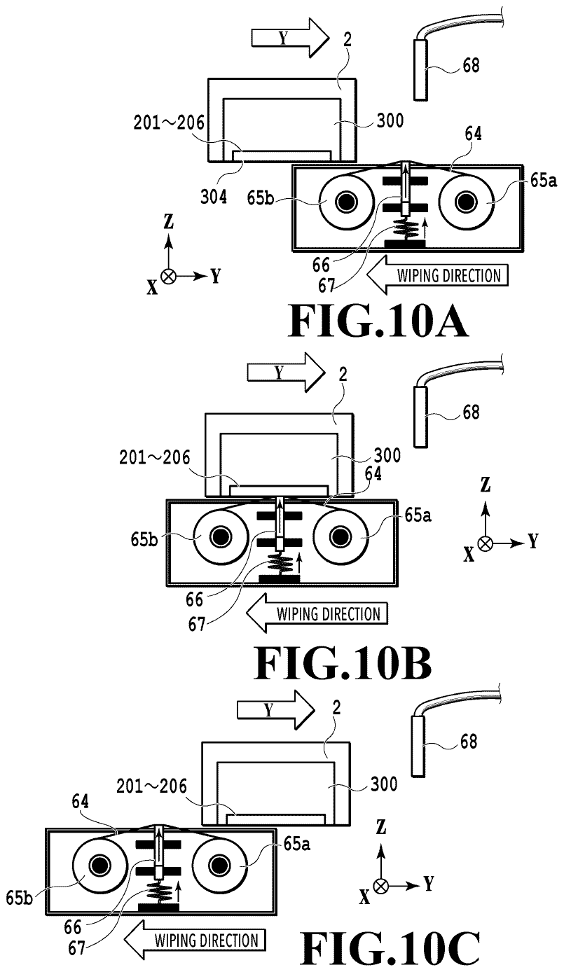

FIG. 9 is a flowchart illustrating a wiping sequence of the printing apparatus 1 of the present embodiment. Additionally, FIGS. 10A to 10C are diagrams illustrating a positional relationship between the print head 300 and the maintenance mechanism 60 in the wiping sequence. The series of processing illustrated in FIG. 9 is performed with the CPU 301 of the printing apparatus 1 deploying a program code stored in the ROM 302 to the RAM 303 to execute. Alternatively, a part of or all the functions of the steps in FIG. 9 may be implemented by hardware such as an ASIC or an electronic circuit. Note that, a symbol “S” in the description of each processing means that it is a step in the flowchart. In the following, the wiping sequence in the present embodiment is described with reference to the flowchart in FIG. 9.

Once the wiping sequence is started, in S901, the CPU 301 moves the maintenance mechanism 60 from a standby position to a position illustrated in FIG. 10A that is a wiping start position. Thereafter, in S902, the CPU 301 rotates the rotation member 65a and the rotation member 65b to roll up the sheet member 64 contaminated by the ink by the previous wiping operation at a predetermined length, and the region of the sheet member 64 that is put in contact with the ejection port surface 403 by the pressing member 66 is changed to an unused surface. For example, about 5 mm of the sheet member 64, which is the length put in contact with the ejection port array, is rolled up. In S903, the CPU 301 moves the pressing member 66 in the Z direction to be positioned in the wiping position. In S904, the CPU 301 performs the wiping operation. In the wiping operation, the maintenance mechanism 60 is moved from the position illustrated in FIG. 10A to the position illustrated in FIG. 10C. The process from FIG. 10A to FIG. 10C is the wiping operation. Thereafter, in S905, the CPU 301 moves the pressing member 66 in a-Z direction to be positioned in the standby position. Then, in S906, the maintenance mechanism 60 is returned to the wiping start position again, and the processing ends.

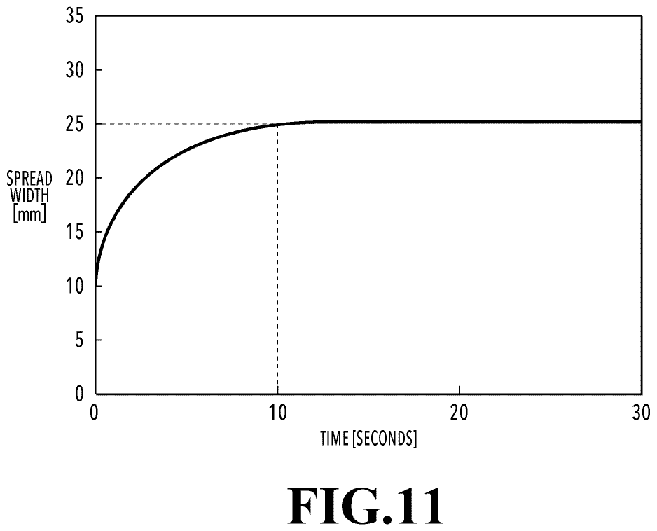

FIG. 11 is a graph illustrating a relationship between the spread width and the time in a case where 0.1 g of the cleaning liquid is applied to the sheet member 64. According to the graph, it can be seen that the time until the cleaning liquid spreads to the above-described desired spread width, which is 25 mm, takes about 10 seconds.

Here, a case where the series of wiping sequence illustrated in FIG. 9 is executed during the print operation is described. The wiping needs to be performed after the cleaning liquid spreads sufficiently on the sheet member 64 after the application. However, in a case where the process from the application of the cleaning liquid to the wiping operation is performed between print scanning and print scanning, the time between print scanning and print scanning becomes long, and a time difference unevenness occurs on the image, or the throughput is reduced. The time difference unevenness herein is a density unevenness or a color development unevenness that occurs due to a variation in the time that elapses between multiple times of print scanning, which are required to complete the image of a unit region, depending on positions on the print medium of the above-described unit region.

On the other hand, in a case where the wiping is executed immediately after applying the cleaning liquid, since the time for the cleaning liquid to spread is insufficient, a large amount of the cleaning liquid needs to be applied to wet the desired spread width of the sheet member 64. Specifically, in a case where the time between multiple times of print scanning that causes no time difference unevenness is 3 seconds, according to the consideration by the inventors, it is necessary to apply 0.5 g of the cleaning liquid to the sheet member 64 in order to wet the desired spread width within 3 seconds.

Therefore, in the present embodiment, print scanning is performed between the application of the cleaning liquid and the wiping operation, and the time of print scanning is utilized to wet the desired spread width with the cleaning liquid.

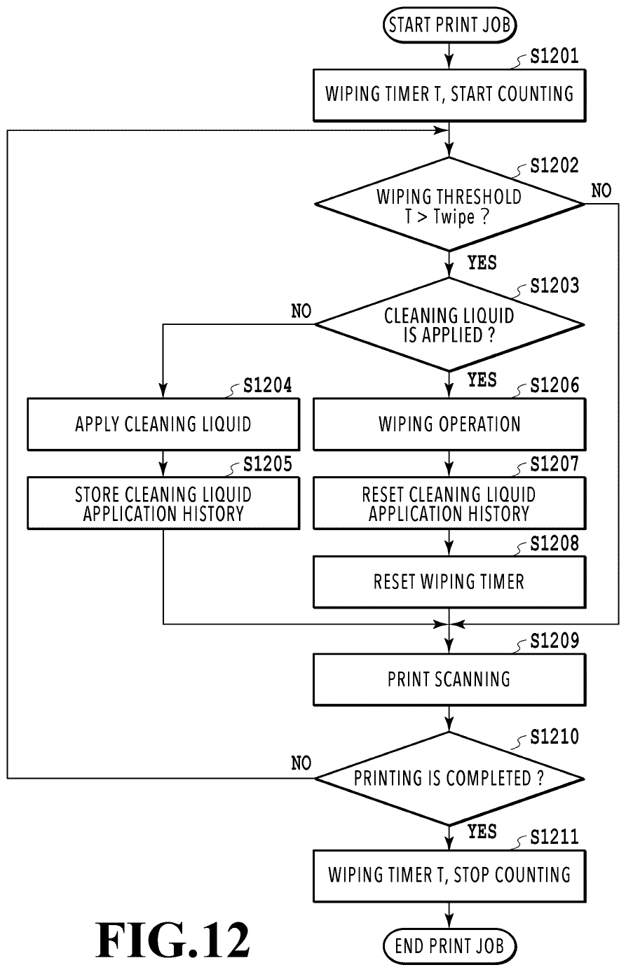

FIG. 12 is a flowchart illustrating processing of a print job in the present embodiment. The processing of the print job described herein is a sequence during the print operation, and the wiping operation performed during the print operation is described. The series of processing illustrated in FIG. 12 is performed with the CPU 301 of the printing apparatus 1 deploying a program code stored in the ROM 302 to the RAM 303 to execute.

Alternatively, a part of or all the functions of the steps in FIG. 12 may be implemented by hardware such as an ASIC or an electronic circuit. Note that, a symbol “S” in the description of each processing means that it is a step in the flowchart. In the following, the processing of the print job in the present embodiment is described with reference to the flowchart in FIG. 12.

Once the print job is started, in S1201, the CPU 301 starts counting a wiping timer T. The wiping timer is a timer that controls a wiping timing during printing, and in the present embodiment, accumulated print operation time after the previous wiping operation is counted to estimate an amount of the mist on the ejection port surface. Note that, the control may not be performed based on the print operation time and may be performed based on the number of ejected ink droplets, for example. Thereafter, in S1202, the CPU 301 compares a wiping threshold Twipe for the necessity of wiping and the wiping timer T and determines whether the wiping timer T exceeds the wiping threshold Twipe. The wiping threshold Twipe herein is the time (accumulated time) of accumulated print operations (accumulated print scanning) that needs the wiping operation, which is set based on a time range in which the mist on the ejection port surface 403 increased by ejection does not affect printing (predetermined accumulated time) that is obtained by an experiment and the like. If the wiping timer T does not exceed the wiping threshold Twipe in S1202 (No), the processing proceeds to S1209, and print scanning is performed. Then, in S1210, whether printing is completed is determined, and if printing is not completed (No), the processing returns to S1202, and the processing is repeated. If the wiping timer T exceeds the wiping threshold Twipe in S1202 (Yes), the processing proceeds to S1203.

In S1203, the CPU 301 determines whether the cleaning liquid is already applied to the sheet member (cleaning liquid application determination). If no cleaning liquid is applied (No), the CPU 301 performs the cleaning liquid application in S1204 and stores a cleaning liquid application history in S1205. Thereafter, print scanning is performed in S1209 without executing the wiping operation, and the processing returns to S1203 again. If the cleaning liquid application history is confirmed in S1203, and the cleaning liquid is already applied (Yes), the CPU 301 proceeds to the wiping operation in S1206. In the wiping operation, the wiping sequence described in FIG. 9 is performed. After the wiping operation is completed, in S1207, the cleaning liquid application history is reset, and in S1208, the wiping timer is also reset. Thereafter, the CPU 301 proceeds to S1209 and performs print scanning. In this process, the maintenance mechanism 60 is positioned in the standby position. If printing is completed in S1210 (Yes), the processing proceeds to S1211 to stop counting the wiping timer, and the processing of the print job ends.

Thus, in the present embodiment, after the cleaning liquid is applied, print scanning is performed until the wiping operation. Note that, in a case of the printing apparatus 1 in the present embodiment, the time required to drop the cleaning liquid on the sheet member 64, perform one scanning of print scanning, and wipe the ejection port surface 403 is 12 seconds. Additionally, in the present embodiment, print scanning performed after the cleaning liquid application described as an example is one scanning; however, multiple number of times of print scanning may be performed, and the number of times of print scanning is not limited. In a case where the number of times of print scanning is multiple number of times, the time required for print scanning takes long; for this reason, it is possible to reduce the application amount of the cleaning liquid to be less than 0.1 g. It should be noted that, if the application amount is less than 0.05 g, the absolute amount of the cleaning liquid is small, and it is impossible to obtain a desired spread width. Therefore, it is desirable to set the number of times of print scanning within a range of the application amount equal to or greater than 0.05 g. Additionally, it is desirable to set properly the time from the cleaning liquid application until the wiping operation, the amount of the cleaning liquid, and the spread width depending on the dimension and the material of the sheet member used. Thus, with print scanning being performed before the wiping operation after the cleaning liquid is applied, the time for spread is secured even with a small amount of the cleaning liquid; therefore, it is possible to reduce the application amount of the cleaning liquid and decrease a consumption amount.

Thus, with print scanning being performed between the cleaning liquid application and the wiping operation to secure the time of 10 seconds or more, the spread width reaches 25 mm even in a case where the application amount of the cleaning liquid is 0.1 g. Therefore, it is possible to decrease a usage amount of the cleaning liquid while maintaining the wiping performance. Additionally, with print scanning being performed between the cleaning liquid application and the wiping operation, it is possible to prevent the occurrence of the time difference unevenness and to maintain the throughput without damaging the water-repellent film of the ejection port surface.

Additionally, in a case where printing is completed immediately after the cleaning liquid application, and no wiping operation is performed, although it is not described, the wiping operation may be performed before the print job ends, or wiping may be triggered by the wiping timer and performed in a next job.

With this, it is possible to provide a technique for the printing apparatus to suppress damage and a reduction in the productivity of the apparatus.

### Second Embodiment

In the following, a second embodiment of the present disclosure is described with reference to the drawings. Note that, since a basic configuration of the present embodiment is similar to that in the first embodiment, in the following, a characteristic configuration is described. In the second embodiment, a mode in which the time from the application of the cleaning liquid until the wiping operation is performed is controlled based on environmental temperature and humidity by the printing apparatus including an environmental temperature and humidity detection unit that detects the surrounding environmental temperature and humidity is described. The printing apparatus of the present embodiment includes the environmental temperature and humidity detection unit that is capable of detecting an environmental temperature and an environmental humidity. Note that, instead of the detection unit, an obtainment unit (a temperature obtainment unit, a humidity obtainment unit) that obtains the environmental temperature and the environmental humidity may be applied.

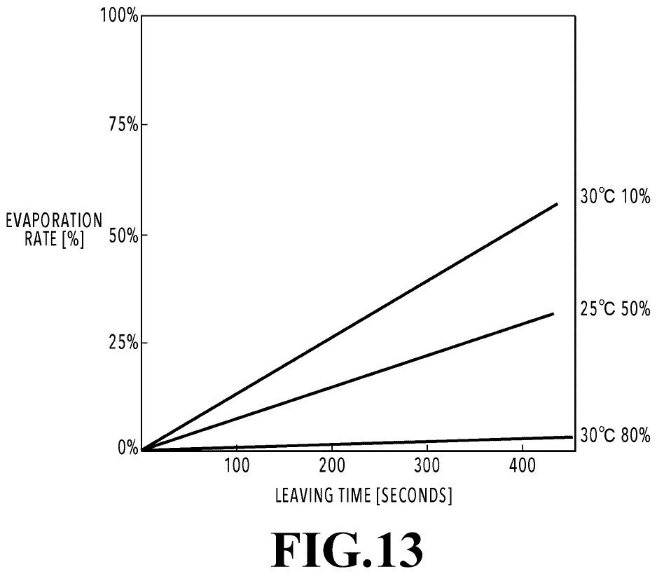

FIG. 13 is a graph illustrating evaporation characteristics at each environmental temperature and humidity after the cleaning liquid is applied to the sheet member 64. After the cleaning liquid is applied to the sheet member 64, the evaporation advances over time, and it becomes difficult to achieve the expected function to soften or dissolve the solidified ink. In other words, the long spread time after the cleaning liquid application is not always optimum, and it is desirable to execute the wiping operation immediately after the desired spread width is obtained.

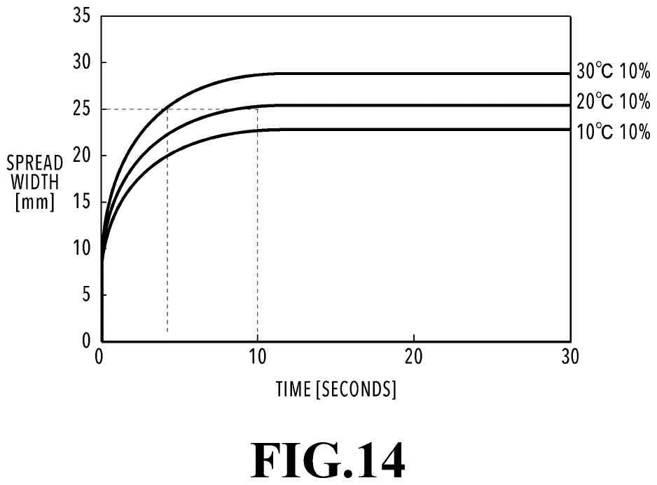

FIG. 14 is a graph illustrating the spread width in a case where 0.1 g of the cleaning liquid is applied to the sheet member 64 at each environmental temperature and humidity. Thus, since a spread speed of the cleaning liquid varies depending on the environmental temperature and humidity, the time required to obtain the desired spread width also varies. According to the above, it is desirable to control the time from the application of the cleaning liquid until the wiping operation is performed depending on the environmental temperature and humidity.

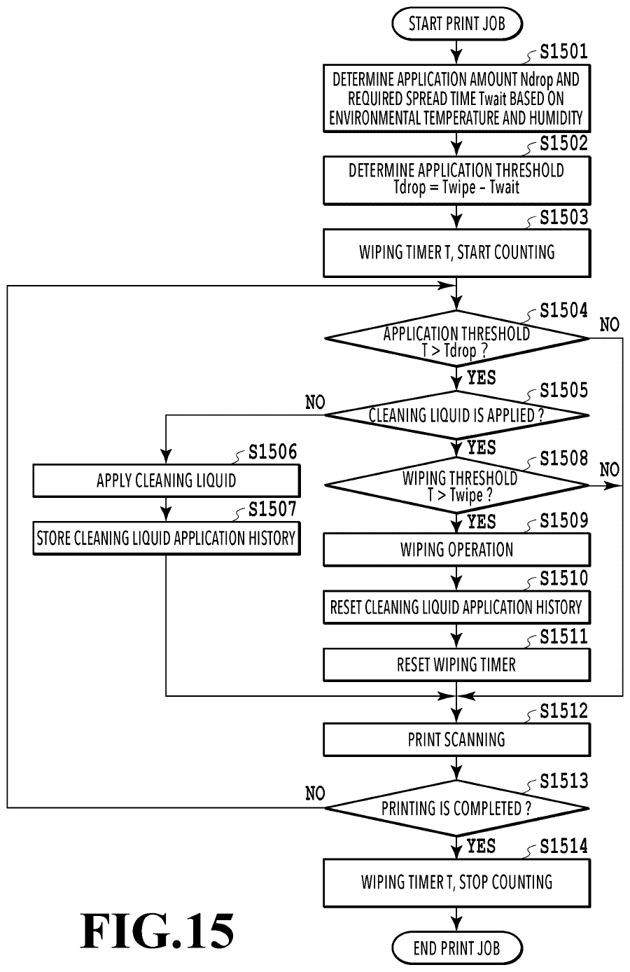

FIG. 15 is a flowchart illustrating processing of the print job in the present embodiment. The processing of the print job described herein is a sequence during the print operation, and the wiping operation performed during the print operation is described. The series of processing illustrated in FIG. 15 is performed with the CPU 301 of the printing apparatus 1 deploying a program code stored in the ROM 302 to the RAM 303 to execute. Alternatively, a part of or all the functions of the steps in FIG. 15 may be implemented by hardware such as an ASIC or an electronic circuit. Note that, a symbol “S” in the description of each processing means that it is a step in the flowchart. In the following, the processing of the print job in the present embodiment is described with reference to the flowchart in FIG. 15.

Once the print job is started, in S1501, the CPU 301 determines a cleaning liquid application amount Ndrop and a desired spread time Twait based on the environmental temperature obtained by an environmental temperature detection unit. A Table 1 is a table determining the cleaning liquid application amount Ndrop that is the cleaning liquid application amount at each environmental temperature and humidity in the present embodiment and the desired spread time Twait. Note that, here, an example in which the humidity is fixed to 50% is described for the sake of easy understanding. In a case where the cleaning liquid application amount Ndrop and the desired spread time Twait are determined for each humidity, a table for each humidity may be prepared. As a matter of course, a table for each temperature and each humidity may be used.

TABLE 1

| | 10° C. to 20° C. | | 20° C. to 30° C. | | 30° C. to 40° C. | |
|---|---|---|---|---|---|---|
| | (50%) | | (50%) | | (50%) | |
| Ndrop | 0.2 | g | 0.1 | g | 0.1 | g |
| Twait | 6 | s | 10 | s | 4 | s |

Next, in S1502, the CPU 301 subtracts the desired spread time Twait from the wiping threshold Twipe to determine an application threshold Tdrop that is a timing in which the cleaning liquid needs to be applied. If the count of the wiping timer T exceeds the application threshold Tdrop, the cleaning liquid needs to be applied. Thereafter, in S1503, the CPU 301 starts counting the wiping timer T, and in S1504, whether the count of the wiping timer T exceeds the application threshold Tdrop is determined. If it is determined in S1504 that the count of the wiping timer T does not exceed the application threshold Tdrop (No), the processing proceeds to S1512 to perform print scanning.

On the other hand, if it is determined in S1504 that the count of the wiping timer T exceeds the application threshold Tdrop (Yes), the processing proceeds to S1505, and the CPU 301 determines whether the cleaning liquid is applied. In S1505, if no cleaning liquid is applied (No), the processing proceeds to S1506, and the CPU 301 performs the cleaning liquid application and stores the cleaning liquid application history in S1507. If it is determined in S1505 that the cleaning liquid is applied (Yes), the processing proceeds to S1508, and the CPU 301 determines whether the count of the wiping timer T exceeds the wiping threshold Twipe. If the count of the wiping timer T does not exceed the wiping threshold Twipe (No), the processing proceeds to S1512, and the CPU 301 performs print scanning. If the count of the wiping timer T exceeds the wiping threshold Twipe (Yes), the processing proceeds to S1509, and the CPU 301 performs the wiping operation. In the wiping operation, the wiping sequence described in FIG. 9 is performed. Thereafter, the CPU 301 resets the cleaning liquid application history in S1510, resets the wiping timer in S1511, and performs print scanning in S1512.

In S1513, the CPU 301 determines whether printing ends, and if printing does not end (No), the processing returns to S1504, and the CPU 301 repeats the processing. If it is determined that printing ends (Yes), the processing proceeds to S1514 to stop counting the wiping timer, and the processing of the print job ends.

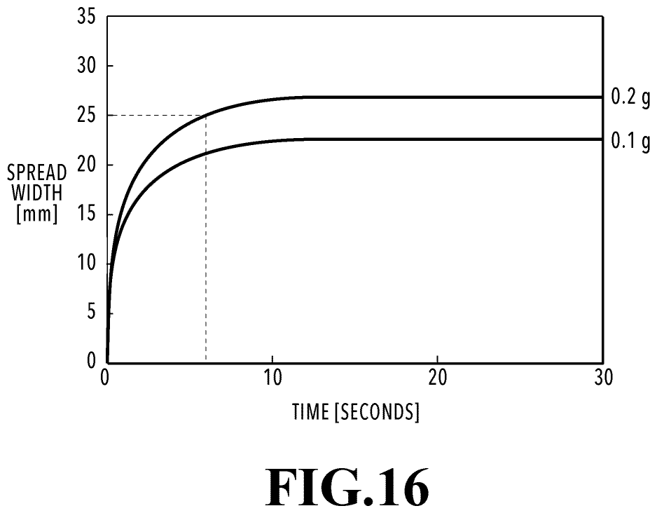

FIG. 16 is a graph illustrating the spread width at each cleaning liquid application amount in a case where the environmental temperature is 10° C. Thus, in an environment in which the cleaning liquid does not spread to the desired spread width even with a long spread time such as a low temperature environment, it is possible to achieve the desired spread width by increasing the application amount of the cleaning liquid. Additionally, as illustrated in FIG. 14, the higher the temperature, the lower the viscosity of the cleaning liquid; for this reason, in a case of the same humidity, the spread speed is faster at a higher temperature. According to the above, as the control of the spread time depending on the environmental temperature in the present embodiment, it is desirable to shorten the time between the cleaning liquid application and the wiping operation more in a case where the temperature is higher. On the other hand, in some environments in which the cleaning liquid does not spread to the desired spread width even with a long spread time such as a low temperature environment, it is desirable to increase the application amount of the cleaning liquid to the sheet member 64.

Additionally, the cleaning liquid application amount Ndrop as the cleaning liquid application amount and the desired spread time Twait may be determined only taking consideration the environmental temperature, or only taking consideration the environmental humidity. As the control of the spread time depending on the environmental humidity, it is desirable to shorten the time between the cleaning liquid application and the wiping operation more in a case where the humidity is higher.

Thus, in the present embodiment, the spread time is controlled by determining the wiping threshold Twipe to secure the desired spread time determined based on the environmental temperature and humidity in addition to the wiping threshold Twipe, and applying the cleaning liquid before the wiping timing. Thus, it is possible to secure the optimum spread time regardless of the surrounding environmental temperature and humidity, and it is possible to provide a technique of suppressing damage and a reduction in the productivity of the apparatus.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-213898, filed Dec. 6, 2024 which is hereby incorporated by reference herein in its entirety.

What is claimed is:

1. A printing apparatus, comprising:
a print head including an ejection port surface in which an ejection port to eject an ink is provided;
at least one wiping member configured to wipe the ejection port surface;
a movement unit configured to move the wiping member in a wiping operation to wipe the ejection port surface with the wiping member; and
a cleaning liquid application unit configured to apply a cleaning liquid to the wiping member before the wiping operation, wherein
the printing apparatus is an ink jet printing apparatus configured to perform the wiping operation by putting the wiping member to which the cleaning liquid is applied in contact with the ejection port surface, and
print scanning by the print head is performed after the cleaning liquid is applied to the wiping member by the cleaning liquid application unit until the wiping operation is performed by the wiping member.

2. The printing apparatus according to claim 1, wherein
the wiping member is formed of a porous material in the form of a sheet.

3. The printing apparatus according to claim 2, further comprising:
a pressing member configured to press the wiping member onto the ejection port surface.

4. The printing apparatus according to claim 1, wherein
the cleaning liquid application unit is a nozzle provided to be able to drop the cleaning liquid onto the wiping member.

5. The printing apparatus according to claim 1, wherein
a plurality of number of times of print scanning is performed after the cleaning liquid is applied to the wiping member until the wiping operation is performed.

6. The printing apparatus according to claim 1, further comprising:
a temperature obtainment unit configured to obtain an environmental temperature, wherein
a time from the application of the cleaning liquid to the wiping member until the wiping operation is performed is set based on the environmental temperature obtained by the temperature obtainment unit.

7. The printing apparatus according to claim 6, wherein
the time is shorter in a case of a high environmental temperature than a case of a low environmental temperature.

8. The printing apparatus according to claim 6, wherein
an application amount of the cleaning liquid is changed depending on the environmental temperature.

9. The printing apparatus according to claim 8, wherein
the application amount of the cleaning liquid is greater in a case of a low environmental temperature than a case of a high environmental temperature.

10. The printing apparatus according to claim 1, wherein
the wiping operation is performed based on predetermined accumulated time of the print scanning

11. The printing apparatus according to claim 1, further comprising:
a humidity obtainment unit configured to obtain an environmental humidity, wherein
a time from the application of the cleaning liquid to the wiping member until the wiping operation is performed is set based on the environmental humidity obtained by the humidity obtainment unit.

12. The printing apparatus according to claim 11, wherein
the time is shorter in a case of a high environmental humidity than a case of a low environmental humidity.

13. A control method of a printing apparatus, comprising:
counting accumulated time of print scanning;
comparing the accumulated time of print scanning with predetermined accumulated time;
determining whether a cleaning liquid is applied to a wiping member;
performing print scanning by a print head after the determining; and
wiping with the wiping member an ejection port surface of the print head in which an ejection port is formed after the performing.
